(19) United States
(12) Patent Application Publication
(10) Pub. No.: US 2011/0161420 A1
(43) Pub. Date: Jun. 30, 2011

(54) COMPUTER-IMPLEMENTED SYSTEM AND METHOD FOR CREATING OPPORTUNITIES TO CONNECT PEOPLE TOGETHER

(76) Inventors: Rachel Kathryn DeAlto, Brick, NJ (US); John Peter DeAlto, Brick, NJ (US)

(21) Appl. No.: 12/982,066

(22) Filed: Dec. 30, 2010

Related U.S. Application Data
(60) Provisional application No. 61/291,046, filed on Dec. 30, 2009.

(51) Int. Cl. G06F 15/16

(52) U.S. Cl. 709/204

(57) ABSTRACT

Embodiments of the present invention are generally related to computer-implemented system and method for creating opportunities to connect people together. In one embodiment, a system for creating opportunities to connect people together comprises a first user having a tangible card, the tangible card having a first unique identifier and a second unique identifier; an accessible data portal, hosted on a server and accessible via a global computer network; a second user having a communication device for accessing the data portal through the global computer network; wherein the second user obtains access to a means for communication with the first user, through physical receipt of the tangible card and subsequent data entry of the first unique identifier and second unique identifier on an access screen of the data portal.

### CROSS-REFERENCE TO RELATED APPLICATIONS

This application claims priority to provisional patent application Ser. No. 61/291,046, filed Dec. 30, 2009, entitled “Computer-Implemented System and Method for Creating Opportunities to Connect People Together,” the disclosure of which is incorporated by reference herein in its entirety.

### BACKGROUND

1. Field of the Invention

Embodiments of the present invention are generally related to a computer-implemented system and method for creating opportunities to connect people together. More specifically, embodiments of the present invention relate to a system and method of creating opportunities to connect people together for romantic or platonic relationships through the utilization of a tangible card having a code thereon, in possession of a first party, and a network-based system, accessible by a recipient of the tangible card.

2. Description of the Related Art

It is not uncommon for a person to be shy, inhibited, intimidated or nervous when attempting to meet another person for purposes of dating, a sexual encounter or merely to become platonic friends. It is also not too uncommon for a person to feel as though she is too busy to devote the time necessary to meet another person for the same or similar reasons.

For these reasons and numerous others, a plethora of types of “dating services” have arisen over the years. Simple dating services, such as ads in the newspaper classified section, provided a cost-effective way to notify readers of the newspaper the ad placer was interested in meeting another person with certain qualities or qualifications, but did not provide any way for the ad placer to limit the person(s) who may contact her. Also, there was no way for a potential respondent to the newspaper ad to know anything about the ad placer, thus leading to potentially awkward situations when the two may finally communicate or meet in person.

Slightly more complex dating services, such as video dating or telephone dating services, allowed a person interested in dating to record a video or audio message, respectively, about the type of person she may be interested in meeting. Again, however, there was no way for the ad placer to limit the person(s) who may contact her. In addition, it is not uncommon for persons wishing to utilize these types of services to experience “performance” nervousness and anxiety, knowing that she would be recorded. As such, many recorded messages give the appearance of a nervous individual, which may be a turn-off to many viewers or potential dates.

The emergence of the Internet greatly expanded and enhanced the dating service industry by allowing individuals to utilize the convenience of a recorded ad or message to find potential mates, while having a virtual screening process by providing a virtual network or marketplace in which users may view each others' profiles, pictures, interests, etc. While existing Internet-based dating services are significant improvements over the services discussed above, they introduce another tier of issues.

The most notable drawback of existing Internet-based dating services is the lack of personal contact or communication, while attempting to facilitate a personal connection. The Internet-based dating services require its users to review each others' written representations of themselves in their profile information to learn who that person is, and view photographs of other (which may be outdated, touched-up, etc.) to determine whether a physical attraction exists. However, all of such information may not be realistically representative of who that person really is now, how that person comes across to others, or most commonly, what that person actually looks like in person. Accordingly, without at least one physical, in-person meeting, it is nearly impossible to determine whether a real attraction exists between two people.

Thus, there is a need for a computer-implemented system and method for creating opportunities to connect people together.

### SUMMARY

Embodiments of the present invention are generally related to computer-implemented system and method for creating opportunities to connect people together. More specifically, embodiments of the present invention relate to a system and method of creating opportunities to connect people together for romantic or platonic relationships through the utilization of a tangible card having a code thereon, in possession of a first party, and a network-based system, accessible by a recipient of the tangible card through entry of the code thereon.

In one embodiment of the present invention, a system for creating opportunities to connect people together comprises a first user having a tangible card, the tangible card having a first unique identifier and a second unique identifier; an accessible data portal, hosted on a server and accessible via a global computer network; a second user having a communication device for accessing the data portal through the global computer network; wherein the second user obtains access to a means for communication with the first user, through physical receipt of the tangible card and subsequent data entry of the first unique identifier and second unique identifier on an access screen of the data portal.

In another embodiment of the present invention, a system for creating opportunities to connect people together comprises a first user having a set of tangible cards issued by an administrator of the system, each of the tangible cards comprising: a pick-up line printed on a first side, and an alphanumeric coded identity of the first user and an alphanumeric one-time use access code printed on a second side, wherein the alphanumeric coded identity is identical on each of the tangible cards in the set, and wherein the alphanumeric one-time use access code is different on each of the tangible cards in the set; an accessible data portal, hosted on a server and accessible via a global computer network; a second user having a communication device for accessing the data portal through the global computer network; wherein the second user obtains access to a means for communication with the first user, through physical receipt of the tangible card and subsequent data entry of the alphanumeric coded identity of the first user and the alphanumeric one-time use access code on an access screen of the data portal.

In yet another embodiment of the present invention, a method for creating opportunities to connect people together comprises providing an accessible data portal, hosted on a server and accessible via a global computer network; creating an account for a first user, the account comprising personal information of the first user, and stored on the server; issuing the first user a tangible card, the tangible card having a first unique identifier and a second unique identifier; and allowing a second user access to a means for communication with the first user, via a communication device, upon physical receipt of the tangible card, and subsequent data entry of the first unique identifier and second unique identifier on an access screen of the data portal.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a system-level network diagram of a system for creating opportunities to connect people together in accordance with one embodiment of the present invention;

FIG. 2 depicts a block diagram of a general computer system, which is capable of being used in connection with the system depicted in FIG. 1, in accordance with another embodiment of the present invention;

FIG. 3 depicts a flow diagram illustrating a method for creating opportunities to connect people together in accordance with one embodiment of the present invention;

FIG. 4 depicts a tangible card having a first unique identifier and a second unique identifier thereon, in accordance with one exemplary embodiment of the present invention;

FIG. 5 depicts a set of tangible cards in accordance with one embodiment of the present invention; and

FIG. 6 depicts a customized tangible card in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Generally, embodiments of the present invention relate to a system and method of creating opportunities to connect people together for romantic or platonic relationships through the utilization of a tangible card having a code thereon, in possession of a first party, and a network-based system, accessible by a recipient of the tangible card through entry of the code thereon.

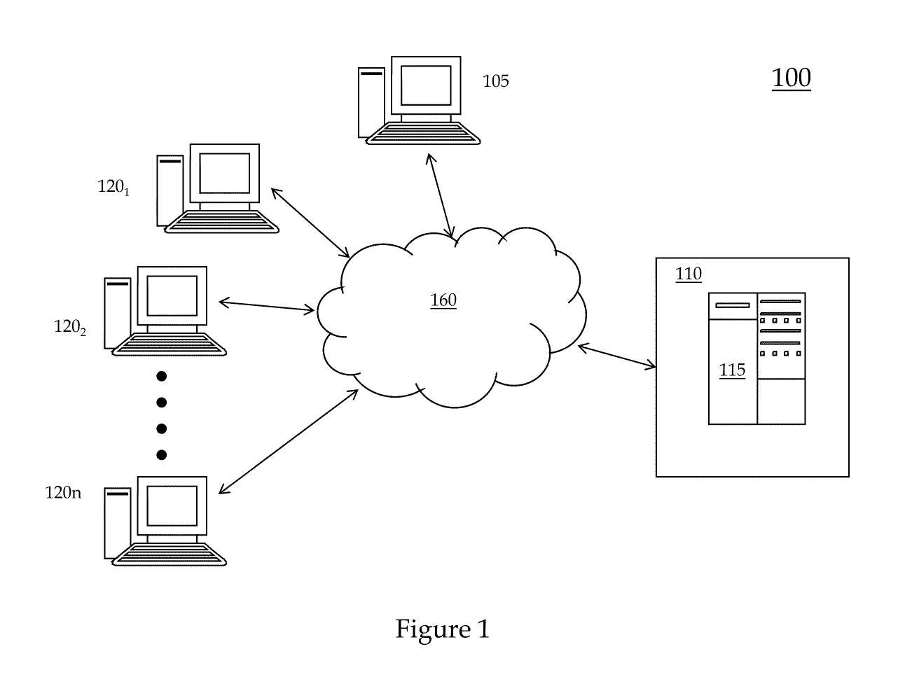

FIG. 1 depicts a system-level network diagram of a system for creating opportunities to connect people together in accordance with one embodiment of the present invention. The system 100 generally comprises at least a first user 105 and secondary users 120₁ and 120₂, each in communication with an administrator 110, generally hosting a central server 115, through a network 150. Methods in accordance with one or more embodiments of the present invention take place over the network 150, which may comprise a global computer network, for example, the Internet.

Although FIG. 1 explicitly depicts three secondary users (labeled “User 2” 120₁, “User 3” 120₂, and “User N” 120_{N}), it should be appreciated that N represents any number of users feasible in accordance with embodiments of the present invention. For ease of reference, as used herein, each of the terms “second user” or “secondary user” may refer to any one or all of the users 120₁, 120₂, and 120_{N} within the system 100. Likewise, although FIG. 1 explicitly depicts only one first user 105, there may be more than one first user 105 in accordance with certain embodiments of the present invention. That is, in certain embodiments, multiple users may perform the same or similar functions as the first user 105. As understood by embodiments of the present invention, a user may include any person, business or entity, capable of participating in the system and methods disclosed herein.

The first user 105 generally has an interest in a person, or persons, with whom the first user 105 may make a personal connection. The interest may be real or hypothetical, and may be regarding the introduction, meeting, date, sexual encounter, or friendship with such a person. Alternatively, the interest may be regarding an attribute of the person. For example, an attribute may comprise a particular physical feature, demographic information, location, income, interests, or the like. In many embodiments, the person in whom the first user 105 has an interest is at least one of the secondary users 120.

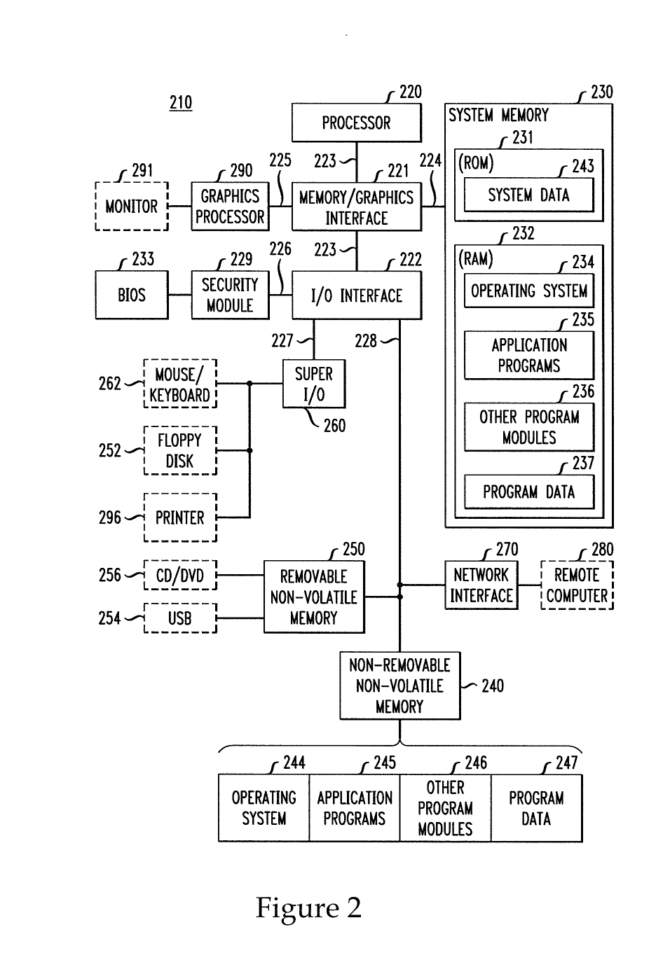

In a basic exemplary embodiment, within the system 100, the first user 105, and/or any of the secondary users 120, may be capable of transmitting data to and from an administrator 110 using a communication device. A communication device in the context of embodiments of the present invention may include, but is not limited to, a personal computer, a portable computer, a handheld computer, a cellular phone, a smart phone, a digital tablet, a laptop computer, a netbook, an Internet appliance, an Apple iPhone, a Blackberry device, a Personal Data Assistant (PDA) or the like, or may generally include a general purpose computer, as discussed below with respect to FIG. 2.

The administrator 110 generally comprises a server 115, which may further host an accessible data portal (e.g., a website, a social network, or the like). The accessible data portal, which may be accessible to the first user 105 and any of the secondary users 120, communicates with each user through the network 160. The accessible data portal may comprise any number of security measures to provide a reasonably secure system, suitable for embodiments of the present invention. The accessible data portal may further comprise a graphical user interface (GUI) through which any of the first user 105 or secondary users 120 may access the server 115.

The server 115 may also comprise a database or other sortable data storage memory to enable the system and methods disclosed herein. In many embodiments, the database may be any commercially available data storage database suitable for embodiments of the present invention. For example, in one embodiment, the database comprises at least one or more database management systems, such as any of an Oracle, DB2, Microsoft Access, Microsoft SQL Server, Postgres, MySQL, 4th Dimension, FileMaker, Alpha Five Database Management System, or the like. Often contained within the database is a plurality of data sets, each comprising specific data. A first data set may correlate to a first user 105, wherein a plurality of user-specific data is stored. The database may also include any number of subsequent data sets representing N users, wherein N represents any number of users practical for operation of embodiments of the present invention.

As explained above, the network 160 may comprise any network suitable for embodiments of the present invention. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G, 3G and 4G telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

In accordance with one embodiment of the present invention, any of the administrator or users may comprise a general purpose computer, for example, as shown in the form of a computer 210 depicted in FIG. 2. As appreciated by embodiments of the present invention, more practical devices, such as mobile devices, mobile telephones, or the like, are likely to be utilized than a general computer 210 for embodiments of the present invention. However, it is also appreciated there is a significant similarity in core components between a mobile device and a general computer 210. The following components are described for exemplary purposes only, and each component's mobile equivalent is also contemplated within embodiments of the present invention.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identification information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of “legacy” peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present invention. It is further understood by embodiments of the present invention, a computing device may comprise all of the elements disclosed in FIG. 2, or any combination of one or more of such elements, in order to perform the necessary functions of the embodiments of the present invention.

It is understood by embodiments of the present invention that a computer, such as the one depicted in FIG. 2, may be connected to a computer network or system. A computer network includes the Internet, a global computer network, an internal computer network, dedicated server networks, and the like.

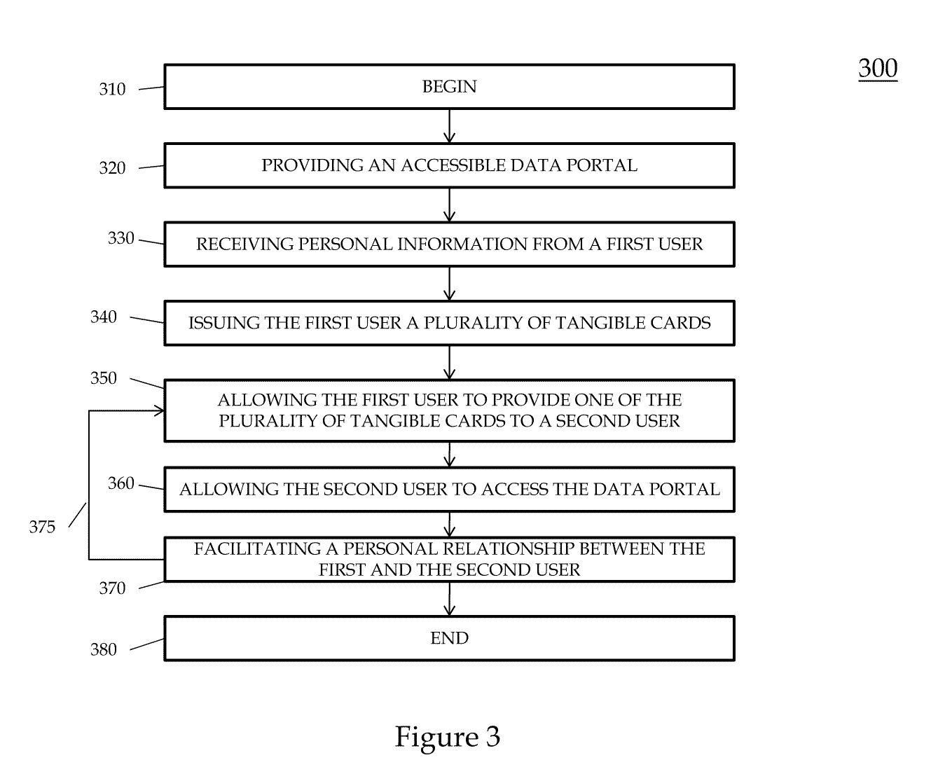

FIG. 3 depicts a flow diagram illustrating a method for creating opportunities to connect people together in accordance with one embodiment of the present invention. The method 300 may be carried out using the architecture and components described in the systems above, or may utilize any other type of system architecture suitable for embodiments of the present invention. It should further be appreciated, the steps of method 300 may be carried out in any order (e.g., step 340 may occur before step 330), unless otherwise explicitly specified by the steps of the exemplary method.

The method 300 begins at step 310. At step 320, an accessible data portal (e.g., interactive website) is provided. The accessible data portal communicates with any number of users through a network, for example a global computer network, such as the Internet. The accessible data portal may comprise any number of security measures to provide a reasonably secure system, suitable for embodiments of the present invention. The accessible data portal may further comprise a graphical user interface (GUI) through which any of the users may access the server or database hosted therein.

At step 330, personal information is received from a first user. In many embodiments, the personal information is used for administrative purposes only, and may not be distributed or accessible to any other members of the system. Such personal information may include, for example, a name, mailing address, email address, telephone number and/or the like. In other embodiments, the first user may provide a username and desired password. Alternatively, the username and password may automatically be assigned by the system, through a random generator or the like. The amount of information provided by the first user may vary depending on the needs of the administrator, and in some embodiments, may only require the providing of a username and password.

In many embodiments, the first user provides the personal information to the system administrator by utilizing a communication device, as described hereinabove. Alternatively, however, the first user may fill out a paper form, place a telephone call to a system operator, or the like, to provide such information to the system administrator.

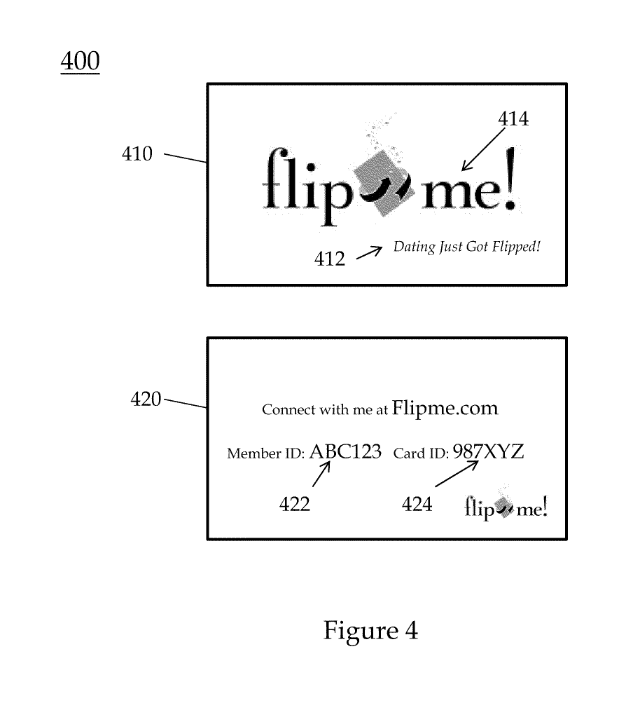

At step 340, the first user is issued at least one tangible card, and in many embodiments, a plurality of tangible cards. An exemplary tangible card in shown in FIG. 4.

As shown in the Figure, a tangible card 400 comprises a front side 410 and a back side 420. In many embodiments, the tangible card 400 may be substantially similar to a business card, i.e., in size, shape, and material. For example, in one embodiment, the tangible card 400 may comprise a 2″×3.5″ rectangular card, made from card stock, paperboard, other cellulose-based products or the like. Alternatively, the tangible card 400 may be manufactured as obscure, odd or non-conventionally sized or shaped cards. In most embodiments, the only requirement for the tangible card 400 is to exist in physical form (i.e., tangible) and to contain information thereon.

The front side 410 of the tangible card 400 may comprise any eye-grabbing material 414 and/or a phrase, slogan 412 or pick-up line, as explained infra. In one embodiment, the tangible card 400 may comprise advertising for the administrator of the system, as shown as the eye-grabbing material 414. As understood by embodiments of the present invention, any form of eye-grabbing printed material 414, including a plain/blank color surface, may suffice.

In many embodiments, the tangible card 400 comprises at least two unique identifiers on the back side 420 thereof. In one embodiment, a first unique identifier 422 may comprise a coded identity of the first user. For example, in some embodiments, the first unique identifier 422 comprises the username of the first user, as described above. In other embodiments, the first unique identifier 422 comprises an alphanumeric coded form of the username of the first user. In yet further embodiments, the first unique identifier 422 comprises an arbitrary code, issued solely to the first user. Generally, the first unique identifier 422 is the same for all the tangible cards issued to the first user; however, in certain embodiments, the first unique identifier 422 may be limited to relatively small subsets (e.g., if thirty (30) tangible cards are issued to the first user, there may be ten (10) different first unique identifiers, each being printed on three (3) cards).

In one embodiment, a second unique identifier 424 may comprise a one-time use access code. Often, the access code may be a randomly generated alphanumeric code, having any number of letters, numbers or other characters, suitable for embodiments of the present invention. For many embodiments, the second unique identifier 424 will only appear once on one tangible card of any number of tangible cards issued to the first user. In other words, the combination of the first unique identifier 422 and the second unique identifier 424 may only appear on one card issued to the first user, regardless of how many other first users or other tangible cards are issued within the system. It should be noted, however, given the limitation of quantity of combinations with numbers, letters and other characters, the second unique identifier 424 may be randomly generated on another user's tangible cards, but only once per set of user's cards, or in extreme cases, only once per set of user's tangible cards per specified time period.

In certain embodiments, it may be feasible to achieve the intent of the first and second unique identifiers with a single identifier on the tangible card. As such, embodiments of the present invention should not be limited to merely two identifiers, and may include any number of identifying codes—each code having a specific purpose.

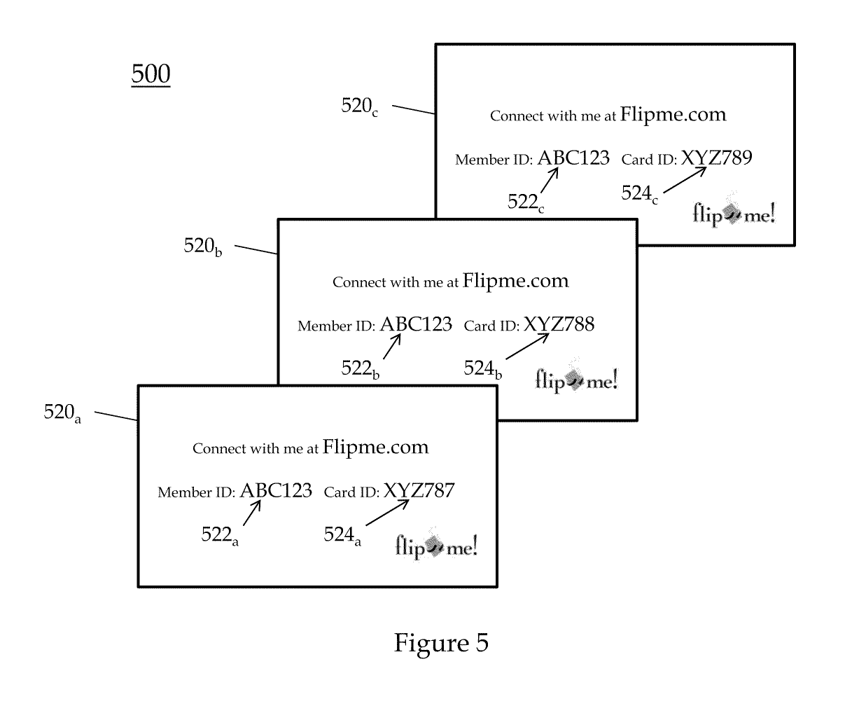

FIG. 5 depicts an exemplary set of tangible cards, in accordance with one embodiment of the present invention. As shown in the Figure, each of the tangible cards 520_{a-c} in the set of tangible cards 500 comprises a first unique identifier 522_{a-c} and a second unique identifier 524_{a-c} respectively. As exemplified in the disclosed embodiment, each of the first unique identifiers 522_{a-c} are common among each of the cards 520_{a-c}. However, as explained above, each of the second unique identifiers 524_{a-c} are different, such that no two cards comprise the same combination of first and second unique identifiers.

In certain embodiments (not shown), either the first 522 or second unique identifier 524 may comprise a sub-set of codes indicative of a location, time frame, or the like. For example, a user may be in possession of a set of tangible cards 500 wherein a sub-set of the set of tangible cards comprise a second unique identifier 524 starting with a first letter or number unique only to that sub-set. In such an example, the user may be able to use the sub-set of tangible cards when out on vacation, at a conference, or the like, such that the user if the user receives multiple messages from multiple recipients of tangible cards, the user will be able to identify at least a temporal or geographical attribute of where she met each of the recipients.

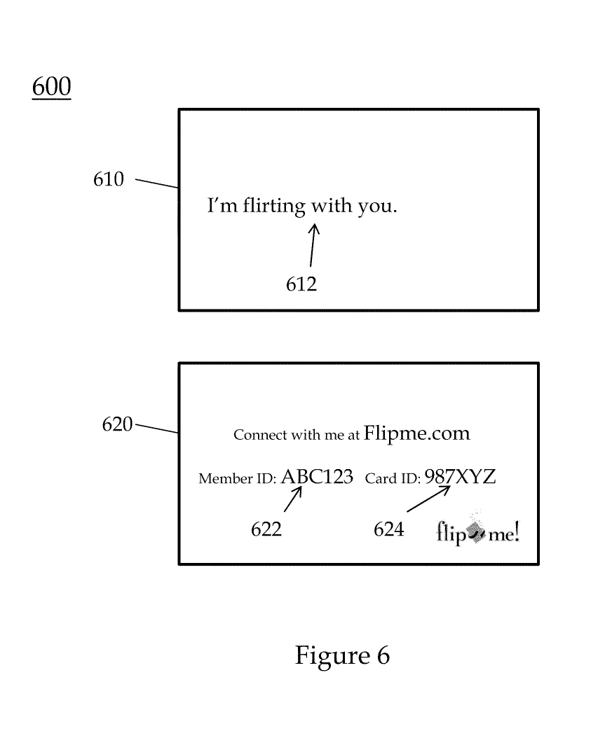

FIG. 6 depicts an alternative embodiment of a tangible card, in accordance with embodiments of the present invention. In certain embodiments, the tangible card 600 may comprise a “pick-up line” 612 or other attention-getting phrase on a front side 610 thereof. For purposes of the embodiments of the present invention, a “pick-up line” may comprise any phrase, statement or expression that when presented to a recipient by a provider (of the pick-up line), is designed to incite an emotional reaction from the recipient, either positive or negative, and which a reasonable recipient would understand the provider's intent.

For example, in some embodiments, the pick-up line 612 may recite a phrase expressing the user's feelings towards the recipient, such as “You are beautiful! Can we get together sometime?” In another example, the pick-up line may comprise a direct and humorous approach aimed at the nature of the system disclosed herein, such as “I'm flirting with you.” In yet another example, a pun-type pick-up line 612 may be utilized, such as “Here's to hoping we play our cards right.” In certain embodiments, a blank space may be provided and the pick-up line 612 may be added by the user by writing in the blank space. Whereas the quality of such types of phrases are subjective, and have vastly differing affects on different people, the wording of such phrase may comprise any wording suitable for embodiments of the present invention.

Returning to FIG. 4, in other embodiments, the tangible card 400 may further comprise instructions for contacting the first user through the system. For example, in one embodiment, on the back side 420 of the tangible card 400, a phrase such as: “Connect with me at: Flipme.com” may be provided. Any other form of instruction may be suitable for embodiments of the present invention as well.

In many embodiments, the tangible card 400 has a printed layout, such that a front side 410 of the tangible card 400 comprises the printed logo or trademark 414 of the administrator, as well as the pick-up line. In such embodiments, the back side 420 may comprise a set of instructions, and the first 412 and second unique identifiers 414. In certain embodiments, the logo of the administrator may also be printed on the second side as well. In certain embodiments, the tangible card 400 may also include advertisements for third parties (not shown). It should be appreciated, however, embodiments of the present invention encompass printing of the requisite information anywhere on the tangible card, regardless of side or positioning.

Although the above description of the tangible cards generally relate to printed cellulose-based cards, it is understood by embodiments of the present invention, the tangible cards may alternatively be in the form of tangible memory storage devices. In such types of embodiments, the data described above may be embedded within a computer-readable medium contained within or on the tangible card. For example, in some embodiments, the tangible cards may comprise a USB-accessible memory drive therein, a RFID chip, or the like, which may be read by an associated reader. As technology progresses, the methods of embodiments of the present invention may be carried out with the same or similar effect, while taking advantage of newer technology.

Similarly, in addition to the description above, the tangible card of the present invention may be in the form of a label or sticker, whereby the tangible card may have information printed on one side only. In an exemplary embodiment, the first user may be able to purchase a drink at a bar, place a label or sticker on the outside of the drink with the first user's information, and drop off the drink to someone the first person wishes to meet. In such embodiments, the label or sticker may generally be a polymer-based label or sticker and may generally be removable, e.g., due to the nature of the materials, a removable adhesive, or the like. In yet further embodiments, the tangible card may be in the form of another tangible article, e.g., flowers, a button, a hat, a t-shirt, a mug, a pen, a coin, jewelry (real or plastic), or the like. In such embodiments, the first user may be quite creative in the method by which she gives out the tangible card(s).

In addition to the above, although many embodiments of the tangible card is described as having certain information on a front side and certain information of back side of the tangible, such placing is for exemplary purposes only. Embodiments of the present invention encompass any placement of the requisite information in connection with the tangible card.

Returning to FIG. 3, at step 350, the first user may provide one of the plurality of tangible cards to a second user. As discussed hereinabove, even a brief physical encounter between two persons (e.g., eyes meeting across a coffee shop, a brief discussion in an elevator, etc.) may provide a mutual sense of attraction or arousal that cannot be attained through a virtual Internet encounter. In accordance with one embodiment of the present invention, rather than worrying about exchanging phone numbers, email addresses or the like, during such a brief encounter, the first user may give the second user one of the plurality of tangible cards, and allow the words thereon to speak for themselves. The actual transfer of the tangible card may occur through any common or creative means or methods. For example, the first user may just hand over one of the tangible cards, slide the tangible card across a table, have a bartender (or other third party) pass the card to a second user across the room, etc.

At step 360, the second user, if interested in connecting with the first user, may access the data portal of the system. In many embodiments, the second user may access the data portal using a communication device through the network. When the second user reaches the data portal, an access screen may require the entry of at least the first and second unique identifier on the tangible card received by the second user. In certain embodiments, the second user may also be able to provide personal information during this step. The personal information may be similar to the personal information provided by the first user above, and in many instances, may only require the submission of a username and/or password.

At step 370, the administrator may facilitate the development of a personal relationship between the first and second user by allowing both the first and second user access any number of means of communication or communication tools within the system. For example, in one embodiment, the first and second user may communicate utilizing an internal mail/message tool, an instant message tool, or the like. In some embodiments, advanced features, such as video messaging or network-assistant voice communication (e.g., Voice over IP technology) may also be available to the users of the system.

Embodiments of the present invention may be fully engaged with the well-known tools a social network. As such, if a relationship extends beyond initial correspondence, as explained in step 370, the first and second user may continue to communicate through sharing of data, including photos, videos, etc., until such relationship is ready to extend beyond the virtual world and back into the real world.

While many lasting relationships may be created using the methods described herein, a possibility always exists that two persons initially interested in one another may not find complete compatibility. Accordingly, at step 375, the method 300 may revert back to step 350 by allowing the first user to provide one of the plurality of tangible cards to a second user. It should also be appreciated, in certain instances, the second user who received the tangible card may not be interested in contacting the first user and pursuing a relationship any further. In such an embodiment, the process would remain at step 350 until a second user elects to proceed with step 360, by accessing the data portal. The method 300 ends at step 380.

There are numerous alternative embodiments of the present invention, which encompass and embody the core features described herein. In one alternative embodiment, the first user may acquire a set of tangible cards as a part of a kit for a particular event (e.g., birthday party, bachelorette party, guy's night out, a “walk of shame” (i.e., the morning after a night of an unexpected personal encounter—whereby the kit may be designed for both the night out and the morning after), etc.). In such an embodiment, the kit may comprise a plurality of items normally utilized for such an event, e.g., balloons, tiaras, leis, prophylactic devices, etc., as well as a set of tangible cards. In many embodiments, the kit may further comprise instructions, challenges or games to be played with the tangible cards, held within the spirit of the event. For example, at a bachelorette party, each of the girls may have to hand out a card to a particular guy with a particular style shirt at the club in which they are holding the party. In another example, a competition could be held to see which of the members of a party could receive the most responses to tangible cards given out at a party. To avoid confusion with a user's normal account, special first and/or second unique identifiers, as discussed above, may be issued with such kits.

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein. In addition, embodiments of the present invention are further scalable to allow for additional clients and servers, as particular applications may require.

What is claimed is:

1. A system for creating opportunities to connect people together comprising:
a first user having a tangible card, the tangible card having a first unique identifier and a second unique identifier;
an accessible data portal, hosted on a server and accessible via a global computer network;
a second user having a communication device for accessing the data portal through the global computer network;
wherein the second user obtains access to a means for communication with the first user, through physical receipt of the tangible card and subsequent data entry of the first unique identifier and second unique identifier on an access screen of the data portal.

2. The system of claim 1, wherein the first unique identifier comprises a coded identity of the first user.

3. The system of claim 2, wherein the first unique identifier comprises an alphanumeric code.

4. The system of claim 1, wherein the second unique identifier comprises a one-time use access code.

5. The system of claim 4, wherein the second unique identifier comprises an alphanumeric code.

6. The system of claim 1, wherein the tangible card comprises a pick-up line on a first side of the tangible card, and the first unique identifier and the second unique identifier on a second side of the tangible card.

7. The system of claim 1, wherein the communication device comprises one of a personal computer, a portable computer, a handheld computer, a cellular phone, a smart phone, a digital tablet, a laptop computer, a netbook, an Internet appliance, a Personal Data Assistant (PDA) or combinations thereof.

8. The system of claim 1, wherein the means for communication comprises one of an electronic mail system, a messaging application, an instant message application, video messaging, network-assistant voice communications or combinations thereof.

9. The system of claim 1, wherein the tangible card is one of a set of tangible cards issued to the first user by an administrator of the system, wherein each of the tangible cards is the set comprise a common first unique identifier and different second unique identifiers.

10. A system for creating opportunities to connect people together comprising:
a first user having a set of tangible cards issued by an administrator of the system, each of the tangible cards comprising:
a pick-up line printed on a first side; and
an alphanumeric coded identity of the first user and an alphanumeric one-time use access code printed on a second side;
wherein the alphanumeric coded identity is identical on each of the tangible cards in the set, and wherein the alphanumeric one-time use access code is different on each of the tangible cards in the set;
an accessible data portal, hosted on a server and accessible via a global computer network;
a second user having a communication device for accessing the data portal through the global computer network;
wherein the second user obtains access to a means for communication with the first user, through physical receipt of the tangible card and subsequent data entry of the alphanumeric coded identity of the first user and the alphanumeric one-time use access code on an access screen of the data portal.

11. The system of claim 10, wherein the communication device comprises one of a personal computer, a portable computer, a handheld computer, a cellular phone, a smart phone, a digital tablet, a laptop computer, a netbook, an Internet appliance, a Personal Data Assistant (PDA) or combinations thereof.

12. The system of claim 10, wherein the means for communication comprises one of an electronic mail system, a messaging application, an instant message application, video messaging, network-assisted voice communications or combinations thereof.

13. A method for creating opportunities to connect people together comprising:
providing an accessible data portal, hosted on a server and accessible via a global computer network;
creating an account for a first user, the account comprising personal information of the first user, and stored on the server;
issuing the first user a tangible card, the tangible card having a first unique identifier and a second unique identifier; and
allowing a second user access to a means for communication with the first user, via a communication device, upon physical receipt of the tangible card, and subsequent data entry of the first unique identifier and second unique identifier on an access screen of the data portal.

14. The method of claim 13, wherein the first unique identifier comprises a coded identity of the first user.

15. The method of claim 13, wherein the second unique identifier comprises a one-time use access code.

16. The method of claim 13, wherein the tangible card comprises a pick-up line on a first side of the tangible card, and the first unique identifier and the second unique identifier on a second side of the tangible card.

17. The method of claim 13, wherein the communication device comprises one of a personal computer, a portable computer, a handheld computer, a cellular phone, a smart phone, a digital tablet, a laptop computer, a netbook, an Internet appliance, a Personal Data Assistant (PDA) or combinations thereof.

18. The method of claim 13, wherein the means for communication comprises one of an electronic mail system, a messaging application, an instant message application, video messaging, network-assistant voice communications or combinations thereof.

19. The method of claim 13, wherein the tangible card is one of a set of tangible cards issued to the first user by an administrator, wherein each of the tangible cards is the set comprise a common first unique identifier and different second unique identifiers.

20. The method of claim 19, wherein the set of tangible cards are issued to the first user as a component of a kit, the kit further comprising a themed set of instructions or challenges for distribution of each tangible card of the set of tangible cards.
